(19) United States
(12) Patent Application Publication
(10) Pub. No.: US 2026/0287499 A1
(43) Pub. Date: Sep. 24, 2026

(54) OPTICAL APPARATUS, OPTICAL INSPECTION APPARATUS, AND OPTICAL INSPECTION METHOD

(71) Applicant: KABUSHIKI KAISHA TOSHIBA, Kawasaki-shi (JP)

(72) Inventor: Hiroshi Ohno, Tokyo (JP)

(73) Assignee: KABUSHIKI KAISHA TOSHIBA, Kawasaki-shi (JP)

(21) Appl. No.: 19/459,230

(22) Filed: Jan. 26, 2026

(30) Foreign Application Priority Data
Mar. 18, 2025 (JP) 2025-043819

(51) Int. Cl. G01N 21/3504; G01N 21/31

(52) U.S. Cl. CPC G01N 21/3504; G01N 21/314; G01N 2201/0648

(57) ABSTRACT

According to an embodiment, an optical apparatus includes: a light receiving element, a light-collecting element array, a diaphragm aperture array, and a first light transmission portion. The light receiving element is configured to receive light and is configured to convert the light into a signal. The light-collecting element array has at least two or more repeating structures. The diaphragm aperture array has at least two or more repeating structures on a focal plane of the light-collecting element array between the light-collecting element array and the light receiving element. The first light transmission portion is filled between the diaphragm aperture array and the light-collecting element array and is configured to transmit the light.

### CROSS-REFERENCE TO RELATED APPLICATIONS

This application is based upon and claims the benefit of priority from Japanese Patent Application No. 2025-043819, filed Mar. 18, 2025, the entire contents of all of which are incorporated herein by reference.

### FIELD

Embodiments described herein relate generally to an optical apparatus, an optical inspection apparatus, and an optical inspection method.

### BACKGROUND

Environmental measurements using light are widely performed. For example, in order to measure the concentration of carbon dioxide in the air, there is a method of irradiating a light receiver (optical apparatus) with an infrared light beam with a wavelength of 4.3 μm as an irradiation beam, and measuring the degree to which light is absorbed by the carbon dioxide during the irradiation. Note that infrared light is emitted from various sources, such as sunlight and an appropriate heat source.

### BRIEF DESCRIPTION OF THE DRAWINGS

FIG. 1 is a schematic view showing a light source and an optical apparatus of an optical inspection apparatus according to an embodiment.

FIG. 2 is a schematic cross-sectional view showing a light-collecting element of the optical apparatus of the optical inspection apparatus shown in FIG. 1.

FIG. 3 is a schematic cross-sectional view showing a diaphragm aperture of the optical apparatus of the optical inspection apparatus shown in FIG. 1.

FIG. 4 is a diagram showing an intensity distribution of light with respect to the optical apparatus according to an embodiment, based on numerical calculations using an FDTD method.

FIG. 5 is a schematic cross-sectional view showing a light-collecting element of an optical apparatus according to a first modification.

FIG. 6 is a schematic cross-sectional view showing a diaphragm aperture of the optical apparatus according to the first modification.

FIG. 7 is a schematic cross-sectional view showing an optical apparatus according to a second modification.

FIG. 8 is a schematic perspective view showing a combination of a light-collecting element and a diaphragm aperture according to a third modification.

FIG. 9 is a schematic cross-sectional view showing an optical apparatus according to a fourth modification.

FIG. 10 is a schematic cross-sectional view showing an optical apparatus according to a fifth modification.

FIG. 11 is a schematic cross-sectional view showing an optical apparatus according to a sixth modification.

FIG. 12 is a schematic cross-sectional view showing an optical apparatus according to a seventh modification.

### DETAILED DESCRIPTION

Hereinafter, an embodiment will be described with reference to the drawings. The drawings are schematic or conceptual, and a relationship between a thickness and a width of each part, a size ratio between parts, and the like are not necessarily the same as actual ones. In addition, even in a case of representing the same part, dimensions and ratios may be represented differently from each other depending on the drawings. In the present specification and each drawing, elements similar to those previously described in connection with preceding drawings are denoted by the same reference signs, and their detailed descriptions are appropriately omitted.

An object of the present embodiment is to provide an optical apparatus an optical inspection apparatus, and an optical inspection method that facilitates separation of an irradiation beam from background noise.

According to the embodiment, the optical apparatus includes: a light receiving element, a light-collecting element array, a diaphragm aperture array, and a first light transmission portion. The light receiving element is configured to receive light and is configured to convert the light into a signal. The light-collecting element array has at least two or more repeating structures. The diaphragm aperture array has at least two or more repeating structures on a focal plane of the light-collecting element array between the light-collecting element array and the light receiving element. The first light transmission portion is filled between the diaphragm aperture array and the light-collecting element array and is configured to transmit the light.

### Embodiment

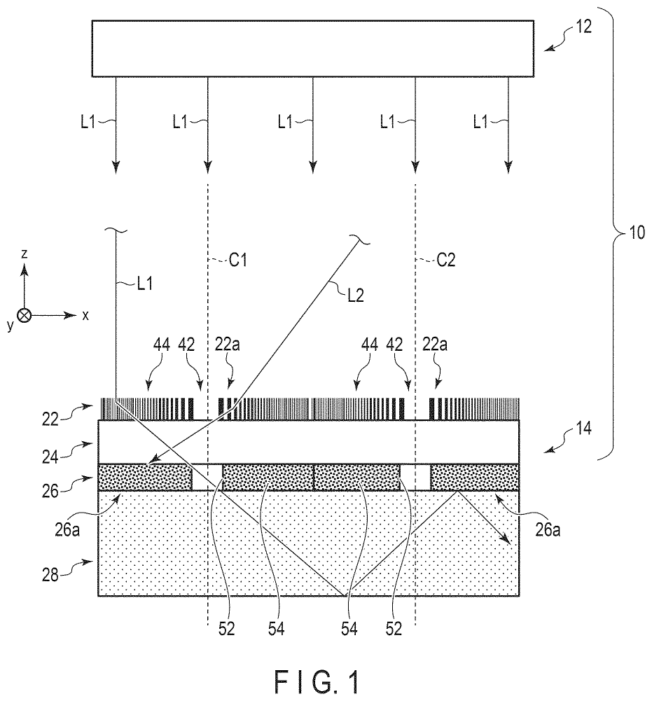

Hereinafter, an optical inspection apparatus 10 according to the present embodiment will be described with reference to FIGS. 1 to 4.

FIG. 1 is a schematic cross-sectional view of the optical inspection apparatus 10 according to the present embodiment.

As shown in FIG. 1, the optical inspection apparatus 10 includes a light source (beam irradiation portion) 12 and an optical apparatus 14 that is configured to receive light (irradiation beam) from the light source 12. In the present embodiment, it is preferable that the light source 12 and the optical apparatus 14 face each other. The light source 12 and the optical apparatus 14 of the optical inspection apparatus 10 in FIG. 1 may be appropriately close to each other or may be appropriately separated from each other.

In the present specification, light is a type of electromagnetic wave, and includes a gamma ray, X-ray, ultraviolet ray, visible light, infrared ray, radio wave, and the like. In the present embodiment, it is assumed that light is infrared light and has a first wavelength of 4.3 μm, for example. However, light is not limited thereto, and may have any wavelength. In the present embodiment, it is preferable that an example of the light source (beam irradiation portion) 12 that emits light of an infrared light wavelength is a semiconductor laser. Among semiconductor lasers as the light source 12, it is preferable to use a quantum cascade laser (QCL).

In the present embodiment, it is preferable to use a surface-emission-type light source as the light source 12. As the surface-emission-type light source 12, it is preferable to use a surface-emission-type light source among quantum cascade lasers as described above. Then, a surface-emission-type quantum cascade laser as the light source 12 is configured to emit a beam with a spectrum containing the first wavelength.

The optical apparatus 14 according to the present embodiment includes a light-collecting element array 22, a light transmission portion 24, a diaphragm aperture array 26, and a light receiving element 28 that is configured to convert light of the first wavelength into a signal.

The light-collecting element array 22 includes a first light-collecting element 22a and a second light-collecting element 22a. The light-collecting element array 22 may have any repeating structure of the same light-collecting element 22a, may have a one-dimensional repeating structure repeated along a line, or may have a two-dimensional repeating structure repeated in a plane. That is, the light-collecting element array 22 may have any repeating structure of at least two light-collecting elements 22a.

Each light-collecting element 22a is configured to collect light. The light-collecting element 22a may be, for example, a metalens, a Fresnel zone plate, a single lens, a lens assembly formed by a plurality of lenses, a concave mirror, a Fresnel lens, a diffraction grating, a gradient index (GRIN) lens, or the like. That is, the light-collecting element 22a may be any element as long as it can collect light.

A surface on which a set of points at infinity is collected by the light-collecting element 22a is defined as a focal plane. The focal plane and its vicinity are referred to as a focal plane region. The first light-collecting element 22a of the light-collecting element array 22 has a first optical axis C1, and the second light-collecting element 22a has a second optical axis C2. These optical axes C1 and C2 are parallel to each other. In the present embodiment, the z axis is in a direction parallel to the optical axes C1 and C2. The optical axes C1 and C2 of the light-collecting elements 22a are straight lines orthogonal to the focal plane. It is assumed that light emitted from sufficiently distant points on the optical axes C1 and C2 of the light-collecting elements 22a is collected at points where the optical axes C1 and C2 intersect with the focal plane. These points are referred to as focal points. Each light-collecting element 22a has a principal surface that is geometrically and optically determined. The distance defined by the focal plane of the light-collecting element 22a and the principal surface closest thereto is defined as the focal length of an imaging optical element.

A metalens (not shown) that can be used as the light-collecting element 22a is a planar lens that controls the direction of light using a fine structure smaller than the wavelength of light. Unlike conventional lenses, a metalens has a characteristic of using a flat thin plane to control the direction of light, instead of using a curved surface to refract light. Structures (meta-atoms) smaller than the wavelength of light (first wavelength in the present embodiment) are regularly arranged on the surface of the metalens. These meta-atoms can locally modulate the phase of incident light, thereby controlling the direction of the light. The metalens is very thin and lightweight while achieving high resolution. However, it should be noted that the surface of the metalens is planar as described above, but has a microstructure on its surface. Therefore, it should be noted that the surface of the metalens can be regarded as a plane when viewed on a macroscopic scale sufficiently larger than the wavelength of light. However, the surface of the metalens can also be a completely flat plane by applying coating or the like.

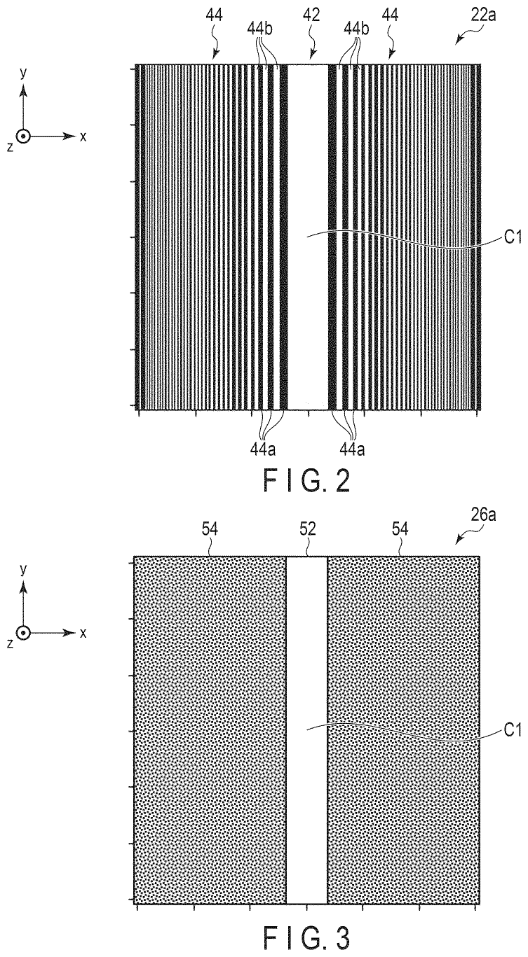

FIG. 2 shows an xy cross-sectional view of the first light-collecting element 22a in the present embodiment. In the present embodiment, each light-collecting element 22a is assumed to be a Fresnel zone plate which is an image forming element utilizing reduced light refraction. Each light-collecting element 22a in the present embodiment is assumed to have a substantially rectangular shape. Each light-collecting element 22a has an opening 42 at the center in the width direction along the x-axis direction. The optical axis C1 is set so as to cross the center of the opening 42 in the width direction along the x-axis direction and the center in the longitudinal direction along the y-axis direction. The opening 42 is formed as a region that allows a light beam of the first wavelength to pass through.

In the ±x-axis direction from the opening 42, a region 44 is provided where a region (opening region) 44a that allows a light beam to pass through and a region (shielding region) 44b that shields a light beam are alternately arranged. Here, it is assumed that the opening region 44a and the shielding region 44b change with respect to the x-axis direction. That is, an example of the first light-collecting element 22a shown in FIG. 2 is a one-dimensional Fresnel zone plate. Note that the regions 44a and 44b extend in the y-axis direction.

In other words, each light-collecting element 22a of the light-collecting element array 22 has a pattern structure formed by at least two substances 44a and 44b in a certain cross section (xy cross section), and at least a part of the pattern structure has a finer pattern from the center toward the outside. The region 44 has a repeating structure (periodic structure) in which the spaces between the regions 44a and 44b are gradually narrowed from the opening 42 toward the +x-axis direction, whereby a light beam incident on the +x-axis direction side is more greatly refracted by diffraction. Similarly, the region 44 has a repeating structure (periodic structure) in which the spaces between the regions 44a and 44b are gradually narrowed from the opening 42 toward the −x-axis direction, whereby a light beam incident on the −x-axis direction side is more greatly refracted by diffraction. For this reason, the region 44 of the first light-collecting element 22a has a finer structure (higher spatial frequency) from the central opening 42 side in the x-axis direction toward the outside. Based on geometric optics, by modulating the spatial frequency in this manner, it is possible to impart a light collecting effect to light in the direction along the optical axis C1. Here, since the first light-collecting element 22a is a one-dimensional Fresnel zone plate that changes in the x-axis direction, it is possible to impart a light collecting effect in the x-axis direction.

Note that the region 44 of the Fresnel zone plate 22a has wavelength dependency. It is assumed that the period of the region 44 of the Fresnel zone plate 22a according to the present embodiment is formed so as to collect light of the first wavelength at a predetermined position. Note that it is preferable that each of the optical axes C1 and C2 intersects with the center between the regions 44 and the center in the y-axis direction in the opening 42 of each light-collecting element 22a.

The light transmission portion 24 is filled between the diaphragm aperture array 26 and the light-collecting element array 22 to transmit light. The light transmission portion 24 may be any material as long as it transmits light. Alternatively, the light transmission portion 24 may be translucent so as to absorb some light. In the present embodiment, the light transmission portion 24 is assumed to be silicon (Si). The light transmission portion 24 is configured to transmit light of the first wavelength.

The diaphragm aperture array 26 includes a first diaphragm aperture 26a and a second diaphragm aperture 26a. In this manner, the diaphragm aperture array 26 may have any repeating structure of the diaphragm aperture 26a, may have a one-dimensional repeating structure repeated along a line, or may have a two-dimensional repeating structure repeated in a plane. That is, the diaphragm aperture array 26 may have any repeating structure of at least two diaphragm apertures 26a.

The diaphragm aperture array 26 is arranged between the light-collecting element array 22 and the light receiving element 28. In the present embodiment, the diaphragm aperture array 26 and the light receiving element 28 are directly joined.

In the present embodiment, it is assumed that the diaphragm aperture array 26 is arranged at or near the focal plane of the light-collecting elements 22a. Each light-collecting element 22a of the light-collecting element array 22 is arranged to face each diaphragm aperture 26a of the diaphragm aperture array 26. The diaphragm aperture 26a allows light in a region including the focal point of the facing light-collecting element 22a to pass through and shields other light. Here, the shielding is performed by absorbing or reflecting light.

As shown in FIG. 3, the first diaphragm aperture 26a includes a region that allows light to pass through in this manner, and this region is referred to as an opening (opening region) 52. Each diaphragm aperture 26a includes a region that shields light, in addition to the opening 52, and this region will be referred to as a shielding region 54. The diaphragm aperture 26a is assumed to have a substantially rectangular shape. The diaphragm aperture 26a includes the opening 52 at the center in the width direction along the x-axis direction. In the present embodiment, it is assumed that the width of the opening 52 is the same as or substantially the same as the width of the opening 42 of the light-collecting element 22a and that the opening 42 of the light-collecting element 22a is located in the +z-axis direction with respect to the opening 52. In the diaphragm aperture 26a, the shielding region 54 is formed in the ±x-axis direction from the opening 52. The optical axis C1 is set so as to intersect with the center of the opening 52 in the width direction along the x-axis direction and the center in the longitudinal direction along the y-axis direction.

As shown in FIGS. 1 and 3, the diaphragm aperture 26a shields light on the surface facing the light-collecting element 22a in the shielding region 54. The shielding region 54 of the diaphragm aperture 26a reflects light on the surface facing the light receiving element 28. That is, the shielding region 54 of the diaphragm aperture 26a shields light by reflection. As a result, light incident on the light receiving element 28 is reflected multiple times by the shielding region 54 of the diaphragm aperture 26a. That is, the light is confined in the light receiving element 28 by the diaphragm aperture 26a.

The light receiving element 28 is configured to receive light and is configured to convert the light into a signal. In the present embodiment, the light receiving element 28 receives light of the first wavelength and converts the light into a signal. When light of the first wavelength is incident on the light receiving element 28, the light receiving element 28 can absorb the light in a specific region or the entire region inside the light receiving element 28, and convert the light into an electric signal. Any region of the light receiving element 28 may absorb light of the first wavelength. For example, it is assumed that the light receiving element 28 has a multilayer film structure formed of a compound semiconductor. This multilayer film structure emits light by applying a voltage to the multilayer film structure, and this multilayer film structure also functions as an element that absorbs light of the first wavelength and converts the light into an electrical signal. That is, it should be noted that this multilayer film structure also functions as a light receiving element. It is preferable that the light receiving element 28 is formed as, for example, a sensor that can detect the first wavelength (infrared light). It is preferable that an example of the light receiving element 28 is a quantum cascade detector (QCD).

Next, the operation of the optical inspection apparatus 10 according to the present embodiment will be described.

It is assumed that a first light beam L1 of the first wavelength is directed from the light source 12 to the optical apparatus 14 along the optical axis C1 of the first light-collecting element 22a.

When the first light beam L1 reaches the light-collecting element 22a, the first light beam L1 passes through the light transmission portion 24 and is collected on the focal point of the first light-collecting element 22a. At this time, since the focal point of the light-collecting element 22a is located in the opening 52 of the diaphragm aperture 26a, the light of the first light beam L1 passes through the opening 52 of the diaphragm aperture 26a and is incident on the light receiving element 28. A part of the light of the first light beam L1 incident on the light receiving element 28 is reflected by the interface (the surface closest to the −z-axis side) of the light receiving element 28 and reaches the diaphragm aperture 26a. Since the shielding region 54 of the diaphragm aperture 26a or the interface (the surface closest to the +z-axis side) of the light receiving element 28 reflects the light of the first light beam L1, the light of the first light beam L1 again propagates through the light receiving element 28. As described above, the light of the first light beam L1 is confined in the light receiving element 28 by the diaphragm aperture 26a. While the first light beam L1 repeats such multiple reflections, the first light beam L1 is absorbed by the light receiving element 28 and converted into a signal.

On the other hand, in a case of a structure in which the first light beam L1 is not reflected by the shielding region 54 of the diaphragm aperture 26a or the interface (the surface closest to the +z-axis side) of the light receiving element 28, the light of the first light beam L1 escapes from the light receiving element 28. For this reason, the light of the first light beam L1 is not sufficiently absorbed by the light receiving element 28, and the signal becomes weak.

The optical apparatus 14 according to the present embodiment has an effect that the light of the first light beam L1 of the first wavelength can be confined, thereby increasing the light receiving efficiency.

It is assumed that a second light beam L2 of the first wavelength is inclined with respect to the optical axis C1 of the first light-collecting element 22a and directed from the light source 12 to the optical apparatus 14.

When the second light beam L2 reaches the first light-collecting element 22a, the second light beam L2 passes through the light transmission portion 24 and reaches the shielding region 54 of the diaphragm aperture 26a, which is at a position out of focus. This is because the second light beam L2 is inclined with respect to the optical axis C1 and is incident on the first light-collecting element 22a. At this time, the second light beam L2 is shielded by the shielding region 54 of the diaphragm aperture 26a and cannot reach the light receiving element 28. That is, the light of the second light beam L2 inclined with respect to the first optical axis C1 cannot reach the light receiving element 28 and cannot be received.

As a result, the optical apparatus 14 according to the present embodiment can only receive light of the first wavelength incident along the optical axis C1 using the light receiving element 28. As a result, the optical apparatus 14 according to the present embodiment has an effect of clearly distinguishing an actively emitted beam of the first wavelength from sunlight incident from various directions toward the optical apparatus 14 and background light from an apparatus that emits other infrared light.

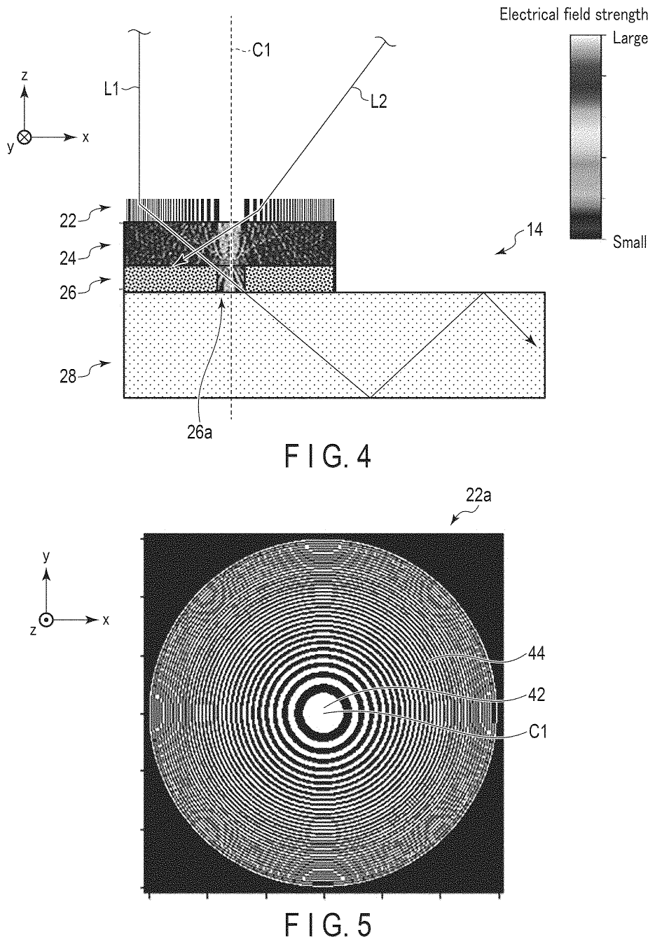

FIG. 4 shows an intensity distribution (electrical field strength) of light of the first wavelength with respect to the optical apparatus 14 according to the present embodiment, based on numerical calculations using a finite difference time domain (FDTD) method. In FIG. 4, illustration of the second light-collecting element 22a, the second diaphragm aperture 26a, and the light transmission portion 24 between the second light-collecting element 22a and the second diaphragm aperture 26a is omitted.

A first incident light L1 of the first wavelength shown in FIG. 4 is parallel light along the optical axis C1. It can be seen that the parallel beam L1 along the optical axis C1 reaches the opening 52 of the diaphragm aperture 26a from the light-collecting element 22a through the light transmission portion 24, passes through the diaphragm aperture 26a, and is incident on the light receiving element 28. On the other hand, a second incident light L2 of the first wavelength shown in FIG. 4 is parallel light inclined with respect to the optical axis C1. It can be seen that the parallel beam L2 inclined with respect to the optical axis C1 reaches the shielding region 54 of the diaphragm aperture 26a from the light-collecting element 22a through the light transmission portion 24.

At this time, if the light-collecting element array 22 of the optical apparatus 14 is irradiated with a beam collimated with respect to the x-axis direction (a beam parallel to the x-axis direction) along the optical axis C1, it has an effect of reducing background noise toward the light receiving element 28 from various directions with respect to the x-axis, thereby improving the S/N ratio of the signal from the irradiated beam.

The light transmission portion 24 is located between the light-collecting element array 22 and the diaphragm aperture array 26, and is connected to them. Therefore, the light transmission portion 24 has an effect of fixing both firmly. In addition, heat generated by the light receiving element 28 is first transferred to the diaphragm aperture array 26. Then, heat conduction occurs in the light transmission portion 24, and the heat can be conducted to the light-collecting element array 22. Then, the heat can be dissipated from the light-collecting element array 22 to the outside. That is, the light transmission portion 24 has an effect of promoting the dissipation of heat generated by the light receiving element 28.

The light transmission portion 24 is fixed to the light-collecting element array 22 and the diaphragm aperture array 26. For this reason, the optical apparatus 14 has an effect that the diaphragm aperture 26a can be accurately arranged at the focal length of the light-collecting element 22a to always maintain the positional relationship. Therefore, the optical apparatus 14 can accurately distinguish light incident on the light receiving element 28.

The upper surface of the light-collecting element 22a of the light-collecting element array 22 is formed to be substantially planar. For this reason, the surface of the light-collecting element 22a is easily coated. Therefore, the optical apparatus 14 according to the present embodiment has an effect that an antireflection film or an abrasion-resistance coating is easily applied to the upper surface of the light-collecting element array 22.

Incidentally, of the surface of the shielding region 54 on the light receiving element 28 side, the interface (the surface closest to the +z-axis side) between the light receiving element 28 and the shielding region 54 on the light receiving element 28 side, and the light receiving element 28, the material that reflects the light L1 of the first wavelength on the surface closest to the −z-axis side may be any material, and may be, for example, gold, silver, copper, aluminum, or the like. Alternatively, the material may be appropriately doped silicon, appropriately doped germanium, cadmium telluride, appropriately doped indium arsenide (InAs), or the like.

For example, the material that transmits the light L1 of the first wavelength in the light transmission portion 24 may be any material, but may be high-purity silicon, ceramics, or the like.

The light-collecting element 22a is a Fresnel zone plate and has strong wavelength dependency. For this reason, if light of a second wavelength different from the first wavelength reaches the light-collecting element 22a, the light-collecting element 22a does not collect the light of the second wavelength. Therefore, as compared with light of the first wavelength, most of light of the second wavelength is shielded by the surface on the +z-axis side in the shielding region 54 of the diaphragm aperture 26a. That is, the optical apparatus 14 according to the present embodiment has an effect of mainly extracting only light of the first wavelength.

In the present embodiment, it has been described that each light-collecting element 22a of the light-collecting element array 22 includes the region 44 in which the region (opening region) 44a that allows a light beam to pass through and the region (shielding region) 44b that shields a light beam are alternately arranged in a certain cross section (xy cross section). For example, it is also preferable that each light-collecting element 22a has a pattern structure in which the region (opening region) 44a that allows a light beam to pass through is formed of air, and the region (shielding region) 44b that shields a light beam is formed of an appropriate substance (at least a substance), and at least a part of the pattern structure has a finer pattern from the center toward the outside.

Therefore, according to the present embodiment, the optical apparatus 14 that facilitates separation of an irradiation beam from background noise is provided.

In the present embodiment, an example has been described in which when light of the first wavelength is incident on the light receiving element 28 through the first light-collecting element 22a, the light transmission portion 24, and the first diaphragm aperture 26a on the first optical axis C1, the light is received. Similarly, when light of the first wavelength is incident on the light receiving element 28 through the second light-collecting element 22a, the light transmission portion 24, and the second diaphragm aperture 26a on the second optical axis C2, the light of the first wavelength can be received by the light receiving element 28. For example, the optical apparatus 14 can detect a change in a medium from the light source (beam irradiation portion) 12 to the optical apparatus 14 from the characteristics of the light of the first wavelength received by the optical apparatus 14.

Then, for example, in a case where a medium, such as a gas, on an optical path between the light source 12 and the optical apparatus 14 of the optical inspection apparatus 10 is sensed using light (infrared light) of the first wavelength from the light source 12, unintended background noise, such as light including infrared rays from sunlight, obliquely incident on the optical axes C1 and C2 of the optical apparatus 14 is prevented from being detected using the optical apparatus 14. For this reason, the optical apparatus 14 effectively receives light of the first wavelength from the light source 12 while eliminating noise. In the light-collecting element array 22, by appropriately arranging the first light-collecting element 22a and using an irradiation beam L1 of the first wavelength of surface emission, it is possible to perform medium sensing in an appropriate region that can be irradiated with the irradiation beam L1 using the optical inspection apparatus 10. Therefore, according to the present embodiment, the optical inspection apparatus 10 that can improve the sensing accuracy of a medium, such as an appropriate gas, is provided.

According to the present embodiment, an optical inspection method includes emitting a beam L1 with a spectrum containing the first wavelength from the beam irradiation portion 12, detecting the spectrum of the beam L1 by the optical apparatus 14 facing the beam irradiation portion 12, and detecting a change in a medium from the beam irradiation portion 12 to the optical apparatus 14 from a characteristic of the light of the first wavelength received by the optical apparatus 14.

In this manner, it is possible to prevent unintended background noise obliquely incident on the optical axes C1 and C2 of the optical apparatus 14 from being detected using the optical apparatus 14 even if it is light of the first wavelength. For this reason, the optical apparatus 14 effectively receives light of the first wavelength from the light source 12 while eliminating noise. Therefore, according to the present embodiment, the optical inspection method that can improve the sensing accuracy of a medium, such as an appropriate gas, is provided.

### First Modification

FIG. 5 shows an xy cross-sectional view of the first light-collecting element 22a of the optical apparatus 14 according to a first modification.

The light-collecting element 22a in the first modification is assumed to have a substantially disk shape. The first light-collecting element 22a has an opening 42 at the center in the width direction along the x-axis direction and at the center in the longitudinal direction along the y-axis direction. Here, it is assumed that the opening 42 has a circular shape. The opening 42 is formed as a region that allows a light beam of the first wavelength to pass through.

In the ±x-axis direction and the ±y-axis direction from the opening 42, the region 44 is provided where the region (opening region) 44a that allows a light beam to pass through and the region (shielding region) 44b that shields a light beam are alternately arranged. For this reason, the first light-collecting element 22a according to the first modification has the opening 42 and the region 44 in which the optical axis C1 is defined at the center of the opening 42 and the opening region 44a and the shielding region 44b are alternately arranged from the opening 42 in the radially outward direction. Here, it is assumed that the opening region 44a and the shielding region 44b change with respect to the radial direction. That is, an example of the first light-collecting element 22a shown in FIG. 5 is a two-dimensional Fresnel zone plate.

Note that the region 44 of the Fresnel zone plate 22a has wavelength dependency. It is assumed that the period of the region 44 of the Fresnel zone plate 22a according to the first modification is formed so as to collect light of the first wavelength at a predetermined position.

This two-dimensional Fresnel zone plate 22a has an effect of imparting a light collecting effect not only in the x-axis direction but also in the y-axis direction.

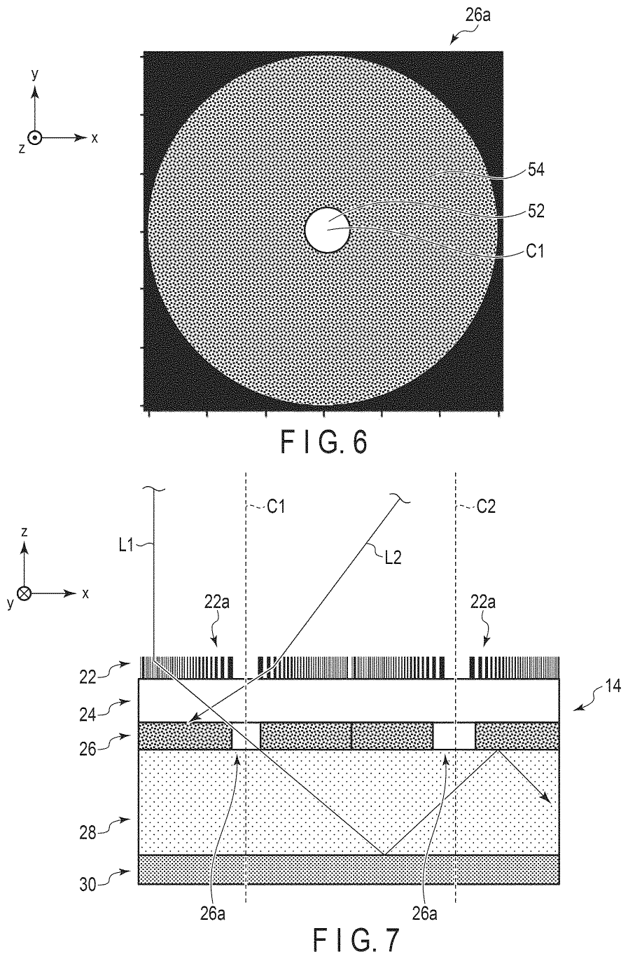

As shown in FIG. 6, the first diaphragm aperture 26a is assumed to have a disk shape. The diaphragm aperture 26a has the opening 52 at the center in the width direction along the x-axis direction and at the center in the longitudinal direction along the y-axis direction. Here, it is assumed that the opening 52 has a circular shape. In the present embodiment, the size of the opening 52 is the same as or substantially the same as the size of the opening 42 of the first light-collecting element 22a, and the opening 42 is located in the +z-axis direction with respect to the opening 52. In the diaphragm aperture 26a, the shielding region 54 is formed in the radially outward direction of the opening 52. The optical axis C1 is set to intersect with the centers of the openings 42 and 52.

When incident light L1, which is parallel light of the first wavelength along the optical axis C1, is incident on the two-dimensional Fresnel zone plate 22a of the optical apparatus 14 according to the first modification, the incident light L1 is collected on the focal point of the Fresnel zone plate 22a through the light transmission portion 24. At this time, since the focal point of the Fresnel zone plate 22a is located in the opening 52 of the diaphragm aperture 26a, the light of the incident light L1 is incident on the light receiving element 28 through the opening 52 of the diaphragm aperture 26a.

On the other hand, when incident light L2, which is parallel light of the first wavelength inclined with respect to the optical axis C1, is incident on the two-dimensional Fresnel zone plate 22a of the optical apparatus 14 according to this first modification, the incident light L2 reaches the shielding region 54 of the diaphragm aperture 26a.

Accordingly, the first light-collecting element 22a has an effect of extracting only a collimated beam directed to the light receiving element 28 along the optical axis C1 from background noise.

Therefore, according to the first modification, the optical apparatus 14 that facilitates separation of an irradiation beam from background noise is provided.

In addition, in the light-collecting element array 22, by appropriately arranging the first light-collecting element 22a and using an irradiation beam L1 of the first wavelength of surface emission, it is possible to perform medium sensing in an appropriate region that can be irradiated with the irradiation beam L1 using the optical inspection apparatus 10. Therefore, according to the first modification, the optical inspection apparatus 10 that can improve the sensing accuracy of a medium, such as an appropriate gas, is provided.

### Second Modification

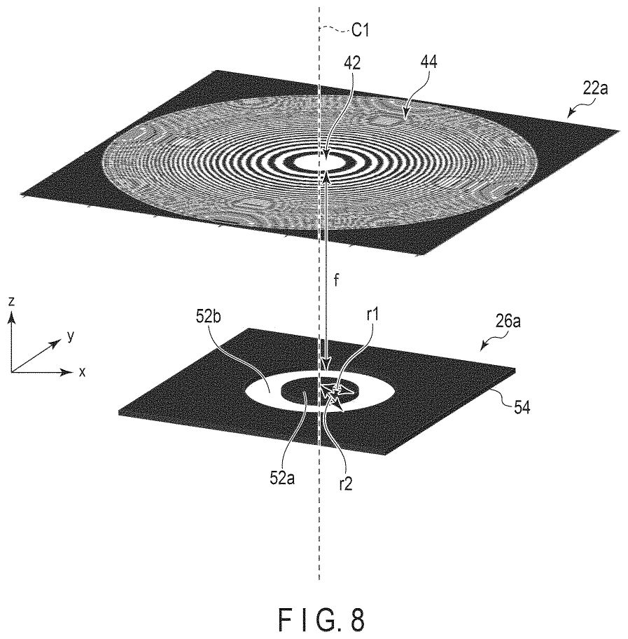

FIG. 7 is a cross-sectional view of the optical apparatus 14 of the optical inspection apparatus 10 according to a second modification. In FIG. 7, illustration of the light source 12 is omitted.

As shown in FIG. 7, the optical apparatus 14 includes a reflection plate (reflection portion) 30 on the side of the light receiving element 28 opposite to the diaphragm aperture array 26. That is, the light receiving element 28 may be sandwiched between the reflection plate 30 and the diaphragm aperture array 26.

The reflection plate 30 reflects light of the first wavelength. As the reflection plate 30, any material that reflects light L1 of the first wavelength may be used, and for example, gold, silver, copper, aluminum, or the like may be used. Alternatively, the material may be appropriately doped silicon, appropriately doped germanium, cadmium telluride, appropriately doped indium arsenide (InAs), or the like.

Since the optical apparatus 14 includes the reflection plate 30, light passing through the diaphragm aperture 26a and incident on the light receiving element 28 can be recursively reflected in the light receiving element 28 more effectively, and it has an effect of improving the light receiving efficiency of light of the first wavelength in the light receiving element 28.

On the other hand, even if the reflection plate 30 is not provided, light is partially reflected by the interface between the light receiving element 28 and the outside thereof, but the amount of retroreflected light can be reduced as compared with a case where the reflection plate 30 is provided.

Therefore, according to the present modified example 2, the optical apparatus 14 that further facilitates the separation of an irradiation beam from background noise as compared with the example of the above-described embodiment is provided.

### Third Modification

FIG. 8 is a schematic perspective view showing a combination of a light-collecting element and a diaphragm aperture according to a third modification.

As shown in FIG. 8, the light-collecting element 22a may be a two-dimensional Fresnel zone plate, and instead of the opening region 52 described as the diaphragm aperture 26a in the first modification, a disk-shaped shielding region 52a intersecting with the optical axis C1 and an annular region 52b outside the shielding region 52a may be provided as an annular opening.

It is assumed that the shape of the shielding region 52a as the annular opening is defined as a first radius r1 from the optical axis C1, and the shape of the annular region 52b as the annular opening is defined as a second radius r2 from the optical axis C1, as shown in FIG. 8. Here, the focal length of the light-collecting element 22a is assumed to be f. At this time, only light of the first wavelength whose angle (radian) with respect to the optical axis C1 ranges from r1/f to r2/f can pass through the annular region 52b as the annular opening. That is, when the light-collecting element 22a is irradiated with a beam L1 of the first wavelength within the angles in such a range, the light receiving element 28 receives the light. This optical apparatus 14 has an effect that when an irradiation beam of the first wavelength as well as background noise of the first wavelength are simultaneously incident on the light-collecting element 22a of the optical apparatus 14, only the irradiation beam can be extracted from the background noise and received by the light receiving element 28.

Therefore, according to the third modification, the optical apparatus 14 that facilitates separation of an irradiation beam from background noise is provided.

### Fourth Modification

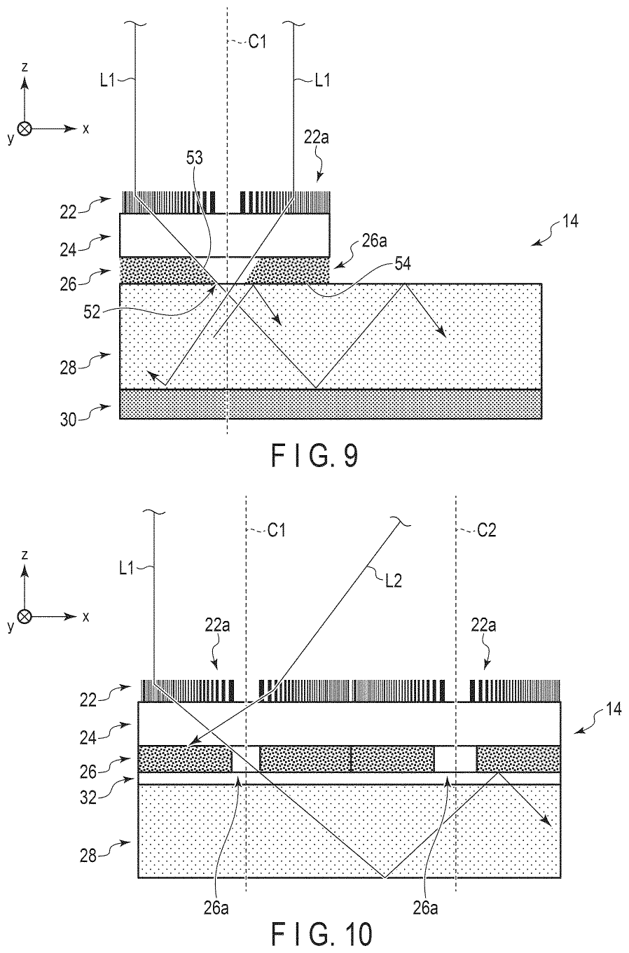

FIG. 9 is a cross-sectional view of the optical apparatus 14 of the optical inspection apparatus 10 according to a fourth modification. In FIG. 9, illustration of the light source 12 is omitted. In FIG. 9, illustration of the second light-collecting element 22a, the second diaphragm aperture 26a, and the light transmission portion 24 between the second light-collecting element 22a and the second diaphragm aperture 26a is omitted.

As shown in FIG. 9, a taper 53 is formed in the opening region 52 of the diaphragm aperture 26a. The taper 53 is formed as a surface where the opening amount increases toward the +z-axis direction side and decreases toward the −z-axis direction side. In the opening region 52 of a diaphragm aperture array 26, at least the surface (shielding region) 54 facing the light receiving element 28 reflects light of the first wavelength. By forming the taper 53, it is possible to increase the amount of light that can be collected from a bundle of a first light beams L1. Furthermore, by forming the taper 53, it is possible to increase the amount of light reflected by the light receiving element 28 and then reflected again by the shielding region 54 (the surface of the light receiving element 28 opposite to the reflection plate 30 side (surface closest to −z-axis side)) of the diaphragm aperture 26a. That is, the light receiving element 28 has an effect of increasing the amount of captured light that has once entered the light receiving element 28 and further increasing the amount of retroreflected light in the light receiving element 28. That is, it has an effect that the light receiving efficiency of the optical apparatus 14 is synergistically increased.

Therefore, according to the fourth modification, the optical apparatus 14 that facilitates separation of an irradiation beam from background noise is provided.

### Fifth Modification

FIG. 10 is a cross-sectional view of the optical apparatus 14 of the optical inspection apparatus 10 according to a fifth modification. In FIG. 10, illustration of the light source 12 is omitted.

As shown in FIG. 10, a second light transmission portion 32 is provided between the diaphragm aperture array 26 and the light receiving element 28. That is, the space between the diaphragm aperture array 26 and the light receiving element 28 is filled with the second light transmission portion 32 that transmits light.

Heat generated by the light receiving element 28 is transferred to the second light transmission portion 32, and then transferred to the diaphragm aperture array 26. Then, heat conduction occurs in the light transmission portion (first light transmission portion) 24, and the heat can be conducted to the light-collecting element array 22. Then, the heat can be dissipated from the light-collecting element array 22 to the outside. That is, the second light transmission portion 32 has an effect of promoting the dissipation of heat generated by the light receiving element 28.

Therefore, according to the fifth modification, similarly to the above-described embodiment and each modification, the optical apparatus 14 that facilitates separation of an irradiation beam from background noise is provided.

### Sixth Modification

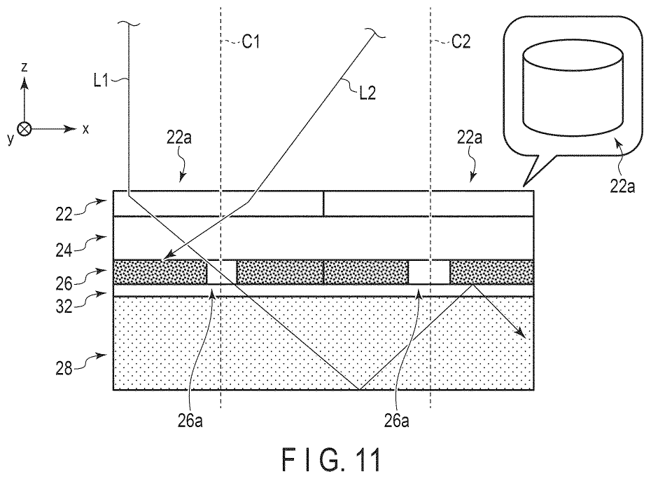

FIG. 11 is a cross-sectional view of the optical apparatus 14 of the optical inspection apparatus 10 according to a sixth modification. In FIG. 11, illustration of the light source 12 is omitted.

As shown in FIG. 11, in the light-collecting element array 22, a gradient index (GRIN) lens 22a is arranged instead of the light-collecting element 22a shown in FIG. 1.

An example of the shape of the gradient index lens 22a is formed in, for example, a rod shape (cylindrical shape). The refractive index decreases from the central axis of the rod of the gradient index lens 22a toward the outer peripheral portion. As the first light-collecting element 22a of the light-collecting element array 22, the gradient index lens 22a shown in FIG. 11 may be used as described above, instead of the light-collecting element 22a, which is the Fresnel zone plate shown in FIG. 1.

Therefore, according to the sixth modification, similarly to the above-described embodiment and each modification, the optical apparatus 14 that facilitates separation of an irradiation beam from background noise is provided.

### Seventh Modification

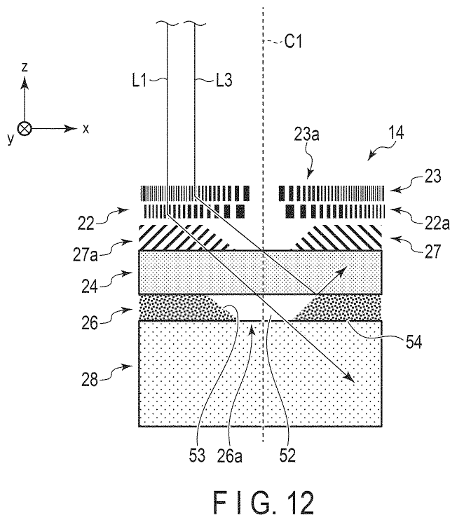

FIG. 12 is a cross-sectional view of the optical apparatus 14 of the optical inspection apparatus 10 according to a seventh modification. In FIG. 12, illustration of the light source 12 is omitted.

In the seventh modification, a second wavelength is assumed to be, for example, 450 nm. That is, the second wavelength is blue light. Silicon reflects and partially absorbs blue light. That is, silicon shields a part of blue light.

In the light-collecting element array 22, a second light-collecting element array 23 is arranged on the light source 12 side. Here, an example of a light-collecting element 23a of the light-collecting element array 23 is a Fresnel zone plate. For this reason, the Fresnel zone plate 23a has strong wavelength dependency. Then, when a first wavelength different from the second wavelength reaches the light-collecting element 23a, the light-collecting element 23a does not collect light of the first wavelength. Therefore, as compared with light of the second wavelength, most of light of the first wavelength is directed to the first light-collecting element array 22 through the second light-collecting element array 23.

A second diaphragm aperture array 27 is provided between the light-collecting element array 22 and the light transmission portion 24. It is assumed that the second diaphragm aperture array 27 is arranged at or near the focal plane of the light-collecting element 23a. A second diaphragm aperture 27a allows light in a region including the focal point of the facing light-collecting element 23a to pass through and shields other light.

Note that the second diaphragm aperture array 27 is made of silicon and arranged as shown in FIG. 12. The second diaphragm aperture array 27 transmits light of the first wavelength.

The light transmission portion 24 transmits light of the first wavelength. Here, it is assumed that the light transmission portion 24 shown in FIG. 12 is mainly made of silicon, and the light transmission portion 24 can receive light of the second wavelength and convert the light into a signal. That is, the light transmission portion 24 may be a light receiving element for the second wavelength.

As described above, in the optical apparatus 14, a third light beam L3 with light of the second wavelength and directing along the optical axis C1 toward the light transmission portion 24 as the second light receiving element can be refracted by the light-collecting element 23a of the light-collecting element array 23, pass through the light-collecting element 22a of the light-collecting element array 22, be received by the light transmission portion (second light receiving element) 24, and be converted into a signal. At the same time, in the optical apparatus 14, a first light beam L1 with light of the first wavelength and directing toward the light receiving element 28 along the optical axis C1 can pass through the light-collecting element 23a of the light-collecting element array 23, be refracted by the light-collecting element 22a of the light-collecting element array 22, be received by the light receiving element 28 through the diaphragm aperture 27a of the diaphragm aperture array 27, the light transmission portion 24, and the diaphragm aperture array 26, and be converted into a signal.

As a result, for example, not only light of the first wavelength in the micrometer range, such as infrared light, but also light of the second wavelength in the nanometer range, such as blue light, can be sensed by an integrated optical apparatus (optical apparatus) 14 in the same manner as for light of the first wavelength. For example, in a case where silicon that absorbs red light is used, red light can also be used as the second wavelength. For this reason, light of the second wavelength is not limited to blue light.

Therefore, according to the seventh modification, the optical apparatus 14 that facilitates separation of an irradiation beam from background noise is provided.

In addition, by appropriately arranging the first light-collecting element 22a and using a beam L1 of the first wavelength in the light-collecting element array 22, and by appropriately arranging the light-collecting element 23a and using a beam L3 of the second wavelength in the light-collecting element array 23, it is possible to perform gas sensing in an appropriate region that can be irradiated with the irradiation beams L1 and L3 using the optical inspection apparatus 10. Therefore, according to the seventh modification, the optical inspection apparatus 10 that can improve the gas sensing accuracy is provided.

According to at least an embodiment described above, it is possible to provide the optical apparatus 14, the optical inspection apparatus 10, and the optical inspection method that facilitate separation of an irradiation beam from background noise. In addition, it is possible to provide the optical inspection apparatus 10 that can improve the gas sensing accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical apparatus comprising:
a light receiving element configured to receive light and convert the light into a signal;
a light-collecting element array having at least two or more repeating structures;
a diaphragm aperture array having at least two or more repeating structures on a focal plane of the light-collecting element array between the light-collecting element array and the light receiving element; and
a first light transmission portion that is filled between the diaphragm aperture array and the light-collecting element array and is configured to transmit the light.

2. The optical apparatus according to claim 1, wherein
a space between the diaphragm aperture array and the light receiving element is filled with a second light transmission portion that is configured to transmit the light, or the diaphragm aperture array and the light receiving element are directly joined.

3. The optical apparatus according to claim 1, wherein
the light receiving element is configured to receive light of a first wavelength and is configured to convert the light into a signal,
the diaphragm aperture array includes:
an opening region that is configured to transmit the light, and
a shielding region that is configured to shield the light, and
the shielding region in a plane facing the light receiving element reflects the light of the first wavelength incident on the light receiving element through the opening region.

4. The optical apparatus according to claim 1, wherein
the light receiving element is configured to receive light of a first wavelength and is configured to convert the light into a signal,
the diaphragm aperture array includes:
an opening region that is configured to transmit the light, and
a shielding region that is configured to shield the light, and
the shielding region in a plane facing the light-collecting element array shields the light of the first wavelength.

5. The optical apparatus according to claim 3, further comprising a reflection portion that is configured to reflect the light of the first wavelength incident on the light receiving element through the opening region of the diaphragm aperture array, wherein
the light receiving element is arranged between the diaphragm aperture array and the reflection portion.

6. The optical apparatus according to claim 1, wherein the light-collecting element array has a repeating structure of a Fresnel zone plate.

7. The optical apparatus according to claim 1, wherein the light-collecting element array has a repeating structure of a gradient index lens having two opposing planes.

8. The optical apparatus according to claim 1, wherein
each light-collecting element of the light-collecting element array has a pattern structure formed by at least two substances in a certain cross section, and
at least a part of the pattern structure has a finer pattern from a center toward an outside.

9. The optical apparatus according to claim 1, wherein
each light-collecting element of the light-collecting element array has a pattern structure formed by at least a substance and air in a certain cross section, and
at least a part of the pattern structure has a finer pattern from a center toward an outside.

10. The optical apparatus according to claim 3, wherein
the opening region of the diaphragm aperture array includes a taper that narrows from the light transmission portion toward the light receiving element.

11. The optical apparatus according to claim 4, wherein
the opening region of the diaphragm aperture array includes a taper that narrows from the light transmission portion toward the light receiving element.

12. The optical apparatus according to claim 3, wherein
the first light transmission portion is configured to receive light of a second wavelength different from the light of the first wavelength and is configured to convert the light of the second wavelength into a signal.

13. The optical apparatus according to claim 4, wherein
the first light transmission portion is configured to receive light of a second wavelength different from the light of the first wavelength and is configured to convert the light of the second wavelength into a signal.

14. An optical inspection apparatus comprising:
the optical apparatus according to claim 3; and
a beam irradiation portion that faces the optical apparatus and is configured to emit a beam with a spectrum containing the first wavelength, wherein
the optical apparatus is configured to detect a change in a medium from the beam irradiation portion to the optical apparatus from a characteristic of the light of the first wavelength received by the optical apparatus.

15. An optical inspection apparatus comprising:
the optical apparatus according to claim 4; and
a beam irradiation portion that faces the optical apparatus and is configured to emit a beam with a spectrum containing the first wavelength, wherein
the optical apparatus is configured to detect a change in a medium from the beam irradiation portion to the optical apparatus from a characteristic of the light of the first wavelength received by the optical apparatus.

16. An optical inspection method comprising:
emitting a beam with a spectrum containing a first wavelength from a beam irradiation portion;
detecting, by an optical apparatus facing the beam irradiation portion, the spectrum of the beam; and
detecting a change in a medium from the beam irradiation portion to the optical apparatus from a characteristic of the light of the first wavelength received by the optical apparatus.
